(19) United States
(12) Patent Application Publication
(10) Pub. No.: US 2024/0372721 A1
(43) Pub. Date: Nov. 7, 2024

(54) Decentralized Key Storage and Retrieval

(71) Applicant: Crown Sterling Limited, LLC, Newport Beach, CA (US)

(72) Inventor: Robert Edward Grant, Laguna Beach, CA (US)

(21) Appl. No.: 18/141,611

(22) Filed: May 1, 2023

(51) Int. Cl. H04L 9/08; H04L 67/1097

(52) U.S. Cl. CPC H04L 9/0894; H04L 9/0825; H04L 67/1097

(57) ABSTRACT

A system for key management that includes a sending computing device that encrypts and sends a message to a receiving computing device. The sending computing device appends location information to the encrypted message that enables the receiving computing device to find a location of the decryption key. The receiving device can authenticate itself with a token to receive the decryption key. This system allows for a decentralized storage of a one-time keypad, where the keys within the keypad are scattered such that a compromise of one storage device does not compromise the entire keypad.

### FIELD OF THE INVENTION

The field of the invention is data security and encryption.

### BACKGROUND

The background description includes information that may be useful in understanding the present invention. It is not an admission that any of the information provided herein is prior art or relevant to the presently claimed invention, or that any publication specifically or implicitly referenced is prior art.

Secure communication of data is an ongoing challenge. As parties looking to access sensitive data increases, those interested in proper data security look to stay one step ahead.

Symmetrical and asymmetrical encryption schemes rely on key exchanges that can be intercepted. One-time pads do not have the problem of key exchange schemes, but must be set up ahead of time and are cumbersome.

Existing third party key providers exist, but existing systems contain vulnerabilities in that key provision services must transmit to a receiving party. Otherwise, the receiving party cannot know how to get a decryption key.

Thus, there is still a need for secure, reliable methods for the exchange of encrypted data without risking key interception.

### SUMMARY OF THE INVENTION

The inventive subject matter provides apparatus, systems and methods in which cryptography keys can be safely and securely managed by being stored and retrieved in a decentralized system.

A first computing device encrypts a set of data with an encryption key to generate the encrypted data. The encrypted data generated during the encryption process includes location data. The first computing device then uses a storage computing device to store a decryption key. The first computing device can be located via the location data within the encrypted data.

The first computing device transmits the encrypted data to a second (receiving) computing device, and the second computing device then uses the enclosed location data to find the storage computing device among many possible storage computing devices. The second computing device retrieves the decryption key from the storage computing device and decrypts the message.

In embodiments of the inventive subject matter, the storage computing device can ask the second computing device for additional credentials before releasing the decryption key.

In embodiments of the inventive subject matter, the location data can be an information address. In other embodiments of the inventive subject matter, the location data can include physical location information. The location data can, in some embodiments, include other reference data that is used to locate the key within the storage computing device.

In embodiments of the inventive subject matter, the second computing device must first provide a cryptographic token that a storage computing device uses to authenticate and verify the second computing device before providing the decryption key.

It will be appreciated that the systems and methods of the inventive subject matter provide for the secure handling and distribution of keys such that, if any one part of the process is compromised, the sensitive data cannot be accessed by an intercepting party.

Various objects, features, aspects and advantages of the inventive subject matter will become more apparent from the following detailed description of preferred embodiments, along with the accompanying drawing figures in which like numerals represent like components.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### BRIEF DESCRIPTION OF THE DRAWING

FIG. 1 is a diagrammatic overview of a system according to embodiments of the inventive subject matter.

FIG. 2 is a flowchart illustrating functions and processes executed by the system according to embodiments of the inventive subject matter.

FIG. 3 is a detailed flowchart of step 250 of FIG. 2.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms, is deemed to represent one or more computing devices having at least one processor (e.g., ASIC, FPGA, DSP, x86, ARM, ColdFire, GPU, multi-core processors, etc.) programmed to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

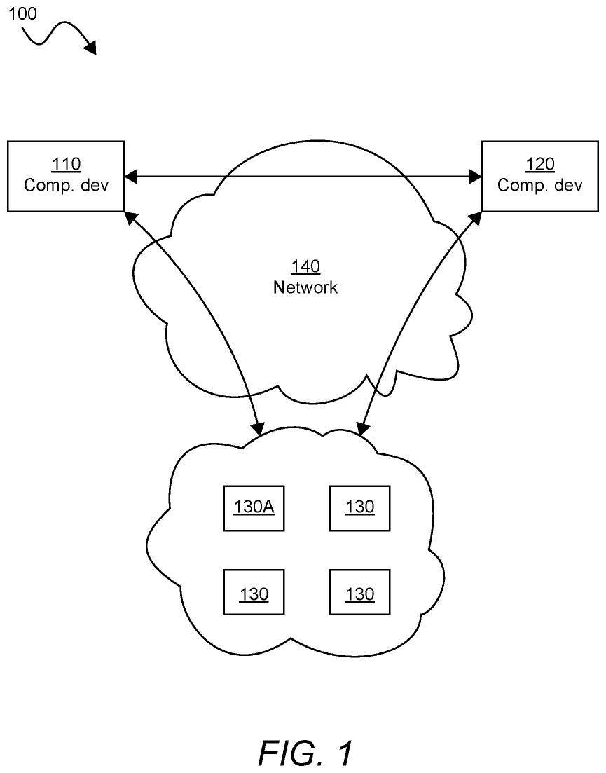

FIG. 1 is a diagrammatic overview of a system 100 according to embodiments of the inventive subject matter.

As seen in FIG. 1, the system 100 includes a first computing device 110 that is capable of exchanging data with a second computing device 120 over known data exchange networks 140 such as the internet.

The system 100 also includes a plurality of storage computing devices 130a-130n (collectively referred to as storage computing devices 130). Each of the storage computing devices 130 includes at least one processor, at least one non-transitory computer-readable storage medium, and at least one communication interface that allows it to exchange data with other computing devices (other storage computing devices 130 as well as other computing devices such as devices 110, 120) over network 140.

In embodiments of the inventive subject matter, the storage computing devices 130 belong to a single distributed storage system that is managed by an operator or organization. In these embodiments, the system that includes the storage computing devices 130 can include an indexing or other organizational computing device that stores the location data of each individual storage computing device 130 within the system. The computing device 110, 120 can consult with this indexing computing device when searching for or depositing keys as discussed herein.

Examples of suitable computing devices 110, 120, 130 can include desktop computers, laptop computers, server computers, tablets, smartphones, game consoles, etc.

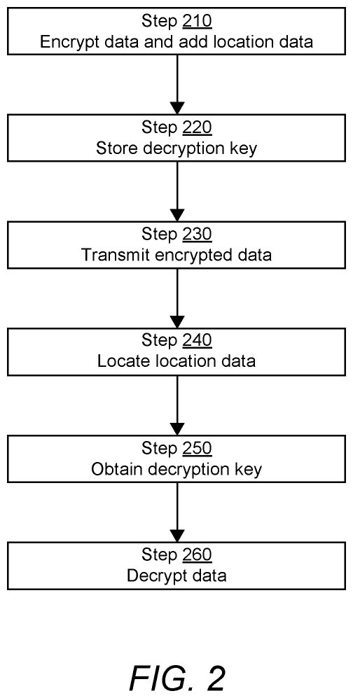

FIG. 2 is a flowchart of the principal processes executed by the system 100, according to embodiments of the inventive subject matter.

At step 210, a first computing device 110 encrypts a set of data with an encryption key to result in encrypted data. The encrypted data includes location data. The location data is information that enables the first computing device 110, the second computing device 120, and any other computing device participating in the system 100 to locate a particular storage computing device 130 via network 140. Examples of location data can include an IP address, a URL, other network addresses, geographic information, physical location information, organization information, index location, organizational location, logical location information, etc.

In embodiments of the inventive subject matter, the location data can also include reference data that enables the storage computing device 130 to locate the key within its own storage. The reference data can include a file name, a pointer to an entry in a database, etc. Thus, in these embodiments, the complete location data will include the location information that enables a computing device such as computing device 110 or computing device 120 to locate the corresponding storage computing device 130 as well as the reference data that enables the storage computing device 130 to further locate the key within its own storage systems without having to have a separate lookup process.

In embodiments of the inventive subject matter such as the one discussed herein, the first computing device 110 generates the encryption key used for encryption. The computing device 110 can obtain location data from one or more of the storage computing devices 130 and selects one of the location data sets to use as discussed herein, which also amounts to a selection of which of the storage computing devices 130 will be used to store the decryption key.

In embodiments of the inventive subject matter, the location data can be appended to the encrypted data. In some embodiments, the location data can be appended at the beginning of the encrypted data. For example, the location data can be in the form of a plurality of digits appended at the start of the encrypted data. In other embodiments, the location data can be appended at the end of the encrypted data. In still other embodiments, the location data can be appended somewhere in the middle of the encrypted data and the location cataloged for later retrieval. The information about the location of the location data within the encrypted data is stored by the computing device 110.

In further embodiments, the encryption key itself is generated based at least in part on information or data about the storage computing device 130. In these embodiments, the storage computing device 130 or the computing device 110 can generate the encryption key based on data associated with the computing device 130 itself. The data can be system configuration data, an identifier, or actual location information such as a network address or a code for a physical location. This data can be fed as a seed into a generator for encryption keys. In embodiments, the data can be appended to the generated encryption keys.

In other embodiments of the inventive subject matter, the encryption key is generated by one of the storage computing devices 130. Thus, prior to step 210, the first computing device 110 obtains one or more encryption keys from one or more of the storage computing devices 130. In embodiments, the first computing device 110 can send a query for keys and receive them directly from one or more of the storage computing devices 130. In other embodiments, the encryption keys can be obtained via a portal or other intermediary device or server such that the requesting computing device 110 does not know which of the storage computing devices 130 has provided a particular encryption key until it is used as discussed below.

In embodiments of the inventive subject matter where the encryption key is generated by a storage computing device 130, the location data of the generating storage computing device 130 can be derived as a function of the encryption key. For example, the computing device 110 can determine the location data based on a corresponding amount of digits of the encryption key. To do this, the computing device 110 takes an amount of the digits of the encryption key that matches the format of the location data for the system 100, and then matches that portion of the digits from the encryption key to the closest matching location data entry within the system. For example, if the location data used in the system is 10 digits long, the computing device 110 takes 10 digits from the encryption key (for example, the 10 first digits, the 10 last digits, or 10 digits from a pre-defined location within the key) and compares the 10 digits against the location data stored in the system for all of the potential locations. Then, it selects the location based on which of the location data is closest to the 10 digit number from the key.

At step 220, the first computing device 110 stores the decryption key at a storage computing device 130. For this illustrative example, the storage computing device 130 will be storage computing device 130A, which is one of the plurality of the storage computing devices 130. The first computing device 110 identifies the storage computing device 130A based on the location data and transmits the decryption key to the storage computing device 130A.

To store the decryption key, the first computing device 110 must first locate the storage computing device 130A among all of the storage computing devices 130. To do so, the first computing device 110 can send a request to the storage computing devices 130. The request includes a request for the storage computing device 130's location information. The request can include a request for available storage space and additional information such as organization information, security information, etc. In embodiments of the inventive subject matter, the request can be handled via a portal or other centralized entry point (which can be executed by one or more of the storage computing devices 130 or another computing device such as a server) that has information about all of the storage computing devices 130 in the system 100. This portal device then transmits the location information of one or more storage computing devices 130 as well as other desired information back to the first computing device 110. In these embodiments, the actual storage computing device 130A selected can be selected by the first computing device 110 or by the portal computing device (such that information about the other computing devices 130 does not reach the first computing device 110).

In embodiments of the inventive subject matter, the first computing device 110 selects the storage computing device 130A based on a time schedule. For example, the first computing device 110 can select the storage computing device 130A based on a time of encryption of the encrypted data. In these embodiments, the first computing device 110 can obtain location data related to more than one storage computing device 130 as discussed herein and can set a schedule to cycle through the computing devices 130 such that the corresponding storage computing device 130 to be used for the storage of the decryption key changes based on the schedule. The first computing device 110 then selects the computing device 130 according to the schedule based on the time of encryption of the data to be sent to the second computing device 120.

The location data associated with the storage computing device 130A is stored by the first computing device 110 such that it is associated with the key, so that the first computing device 110 later can retrieve the location data for use with the encrypted data as discussed further below.

In embodiments of the inventive subject matter, the encryption used by the first computing device 110 is a symmetrical encryption scheme. In these embodiments, the encryption key and decryption key are identical. As such, the computing device 110 transmits a copy of the encryption key to the storage computing device 130A at step 220 which will later be treated as the decryption key sent to the device 120 as discussed further below. In embodiments where a symmetrical encryption scheme is used or mentioned, it is understood that an “encryption key” and a “decryption key” are identical and the terminology is used to clarify the role of the key in the process.

In other embodiments of the inventive subject matter, the encryption scheme used is asymmetrical. In this case, the computing device 110 generates (or obtains from elsewhere) the encryption keys and decryption keys and transmits the decryption key to the storage computing device 130A.

In embodiments of the inventive subject matter, the system 100 can be used to decentralize a one-time keypad made up of a plurality of single-use encryption and decryption keys. In these embodiments, the first computing device 110 can generate or obtain a plurality of encryption/decryption keys (for symmetric schemes) or encryption-decryption key pairs (for asymmetric schemes). In these embodiments, the first computing device 110 can send a key used for decryption corresponding to each encryption key to one or more of the storage computing devices 130, and store their corresponding location data. In some embodiments, each decryption key is stored in a different storage computing device 130 such that no storage computing device 130 has more than one decryption key associated with the first computing device 110.

In embodiments where the storage computing devices 130 generate the keys, the decryption key will already be in storage the transfer of the keys from the first computing device 110 to the storage computing device 130 is not necessary.

At step 230, the first computing device 110 transmits the encrypted data to the second computing device 120. The transmission can include information regarding the location of the location data within the encrypted data if this knowledge has not been a priori established by the first computing device 110 and the second computing device 120. In other embodiments of the inventive subject matter, the information regarding the location of the location data within the encrypted data

At step 240, the second computing device 120 locates the location data within the encrypted data and then uses the location data to locate the storage computing device 130A among the plurality of storage computing devices 130 that has the decryption key for the received encrypted data. As noted above, the location data can come in many forms that enable the second computing device 120 to locate the storage computing device 130A, including an IP address, a URL, etc.

At step 250, the second computing device 120 obtains the decryption key from the storage computing device 130A.

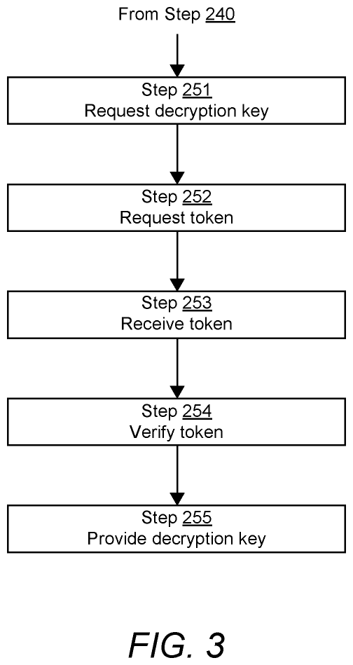

In embodiments of the inventive subject matter, obtaining the decryption key at step 250 can include the following steps, illustrated in the flowchart of FIG. 3:

First, the second computing device 120 sends a request for the decryption key to the storage computing device 130A at step 251. Upon receiving that request, the storage computing device 130A requests a token at step 252 from the second computing device.

In response, the second computing device provides the token to the storage computing device at step 253. The token can be an additional piece of data that authenticates the second computing device 120.

In embodiments of the inventive subject matter the token is a set of encrypted data that was previously generated by the computing device 110 and sent to the storage computing device 130, or by the storage computing device 130A and sent to the computing device 110. The data is stored by the storage computing device 130A in unencrypted form. In these embodiments, upon receiving the request the storage computing device 130A can request a decryption key for the token (or already have a decryption key for the token) from the first computing device 110. Upon receiving (or accessing, if the key is already stored by the storage computing device 130A) the decryption key for the token, the storage computing device 130A decrypts the token and compares it against the unencrypted token data it already stored. If the decrypted token data from computing device 120 matches the unencrypted token data from device 110, then computing device 120 has been authenticated.

In embodiments of the inventive subject matter the token is a hash that was previously generated by the computing device 110 and then sent to the storage computing device 130A along with the decryption key, or by the storage computing device 130A and sent to the computing device 110. The hash is sent from the computing device 110 to the second computing device 120 along with or in a separate message from encrypted data. The hash provided by the second computing device 120 is compared, by the storage computing device 130A, against a hash stored by the storage computing device 130A, and with a match the second computing device 120 is authenticated.

At step 254, the storage computing device verifies the token and provides the decryption key to the second computing device at step 255.

In embodiments of the inventive subject matter, the token is not used in the process and as such steps 252-254 are not executed.

At step 260, the second computing device 120 then decrypts the encrypted data using the obtained decryption key.

The astute reader will appreciate that, in one-time keypad use, the systems and methods of the inventive subject matter enable for the decentralized storage and distribution of the decryption keys within the keypad. In the processes discussed above, it is unlikely that an intercepting party would be able to obtain the decryption keys from storage computing device 130A. However, even if an intercepting party could somehow decode the location of the storage computing device 130A, spoof the token and obtain the decryption key, this exposure would not compromise any other keys stored in other computing devices 130 because the intercepting party would still not know about them (or how many keys there might be, or any other information). As such, the damage of the exposure would be contained. It is thus appreciated that the systems and methods of the inventive subject matter provide enhanced layers of data security for data and key exchange applications.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for decentralized key management, comprising:
encrypting, by first computing device and using a first encryption key, a set of data to generate encrypted data, wherein the encrypted data includes a location data;
storing, by the first computing device, a decryption key at a storage computing device among a plurality of storage computing devices, wherein the storage computing device corresponds to the location data;
transmitting, by the first computing device and to a second computing device, the encrypted data;
identifying, by the second computing device, the storage computing device among the plurality of storage computing devices based on the location data;
retrieving, by the second computing device, the decryption key from the storage computing device; and
decrypting, by the second computing device, the encrypted data to obtain the set of data.

2. The method of claim 1, wherein the step of retrieving the decryption key further comprises:
receiving, by the storage computing device and from the second computing device, a request for the decryption key;
requesting, by the storage computing device, a token;
providing, by the second computing device and to the storage computing device, the token; and
providing, by the storage computing device and in response to receiving the token, the decryption key to the second computing device.

3. The method of claim 1, wherein the plurality of storage computing devices belong to a single distributed storage system.

4. The method of claim 1, wherein the location data comprises an information address.

5. The method of claim 1, wherein the location data includes reference data.

6. The method of claim 1, wherein the location data comprises information appended to the encrypted data.

7. The method of claim 1, wherein the location data is derived as a function of the encryption key, and the encryption key is generated based on storage computing device.

8. The method of claim 1, wherein the decryption and encryption key are identical.

9. The method of claim 1, wherein the first computing device obtains the encryption key from the storage computing device.

10. The method of claim 1, wherein the decryption and encryption key are different.

11. The method of claim 1, further comprising selecting, by the first computing device, the storage computing device based on a time of encryption.
